(19) United States
(12) Patent Application Publication
(10) Pub. No.: US 2024/0120721 A1
(43) Pub. Date: Apr. 11, 2024

(54) SPLICED WIRE ELECTRICAL JUNCTION BOX

(71) Applicants: Justin Jones, Virginia Beach, VA (US); Daniel Bonomo, Virginia Beach, VA (US)

(72) Inventors: Justin Jones, Virginia Beach, VA (US); Daniel Bonomo, Virginia Beach, VA (US)

(21) Appl. No.: 17/962,448

(22) Filed: Oct. 7, 2022

(51) Int. Cl. H02G 3/08; H02G 3/14

(52) U.S. Cl. CPC H02G 3/083; H02G 3/14

(57) ABSTRACT

An example includes a first box half with a top first half bushing, a bottom first half bushing, and a second box half with a top second half bushing, and a bottom second half bushing, and the first box half and the second box half are separate and are affixed to one another by a hinge with a rotating axis. The box in a closed position provides a way to shield and protect a wire splice.

### FIELD OF INVENTION

The present invention relates to a box for electrical wiring and more particularly to a spliced wire electrical junction box.

### BACKGROUND OF THE INVENTION

Conventionally, wire splicing may be performed in various areas of a home or building without secure wire management. National Fire Protection Agency (NFPA) and the national electrical code (NEC) exist to govern standards to protect the citizens of the United States and other areas from faulty electrical work. A loose wire or exposed wire can lead to a fire, electrocution and other hazards.

When wiring a home or business location, the initial efforts to comply with the code and perform satisfactory work may be checked by an inspector of the municipality. However, as work needs to be done once a building is erected, the quality of the work may be less than optimal as it pertains to the ‘code’ since smaller projects often finish without a thorough inspection. Splicing, cutting, joining, etc., a wire along its intended path may be a common and everyday type of project. Ensuring the spliced wire is properly secured and out of harm's way is a task that can often be overlooked.

### SUMMARY OF THE INVENTION

Example embodiments of the present application disclose an apparatus that includes a first box half with a top first half bushing, and a bottom first half bushing, and a second box half including a top second half bushing, and a bottom second half bushing, and the first box half and the second box half are separate and are affixed to one another by a hinge with a rotating axis.

In a closed position the first box half and the second box half are locked together by a securing tab on one of the first box half and the second box half being latched onto a resting lip on the other of the first box half and the second box half. The first box half and the second box half are bound on one side by the hinge. The securing slots on the first box half align with securing slots on the second box half when the box is in a closed position. The top and bottom second half bushings and the top and bottom first half bushings each have an equal number of bushing tabs. The top and bottom second half bushings and the top and bottom first half bushings are a same material as the first and second box halves. The top and bottom second half bushings and the top and bottom first half bushings are a different material as the first and second box halves. The top and bottom second half bushings and the top and bottom first half bushings have a thinner material of a same type of material as the first and second box halves. The top and bottom second half bushings and the top and bottom first half bushings have a thinner material of a different type of material as the first and second box halves.

Another example apparatus may include a first box half with a top first half bushing, and a bottom first half bushing, and a second box half with a top second half bushing and a bottom second half bushing, and in a closed position the first box half and the second box half form a complete top bushing and a complete bottom bushing.

### BRIEF DESCRIPTION OF THE DRAWING(S)

FIG. 1A illustrates a front angled view of a first half of a splice box according to example embodiments of the present application.

FIG. 1B illustrates a rear angled view of a first half of a splice box according to example embodiments of the present application.

FIG. 1C illustrates a top view of a first half of a splice box according to example embodiments of the present application.

FIG. 1D illustrates a rear view of a first half of a splice box according to example embodiments of the present application.

FIG. 1E illustrates a front angled view of a second half of a splice box according to example embodiments of the present application.

FIG. 1F illustrates a rear angled view of a second half of a splice box according to example embodiments of the present application.

FIG. 1G illustrates a top view of a second half of a splice box according to example embodiments of the present application.

FIG. 1H illustrates a rear view of a second half of a splice box according to example embodiments of the present application.

FIG. 2A illustrates a front angled view of the first half and the second half of the splice box together in a closed position according to example embodiments of the present application.

FIG. 2B illustrates a rear angled view of the first half and the second half of the splice box together in a closed position according to example embodiments of the present application.

FIG. 2C illustrates a front angled view of the first half and the second half of the splice box in an open position according to example embodiments of the present application.

### DETAILED DESCRIPTION OF THE EMBODIMENT(S)

Example embodiments provide an electrical wire/conduit housing/box that provides an optimal and efficient way to secure a spliced cable.

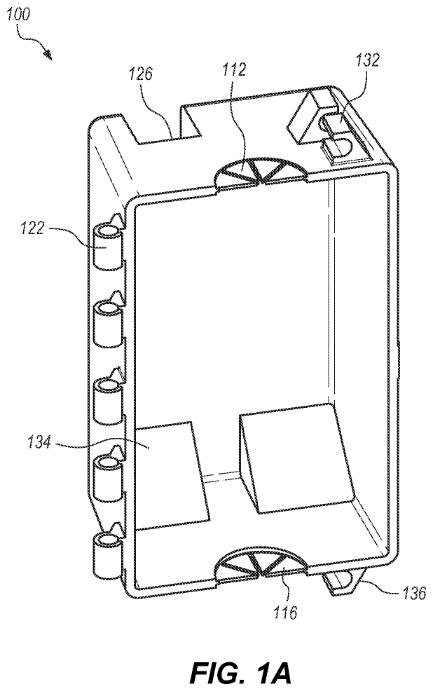

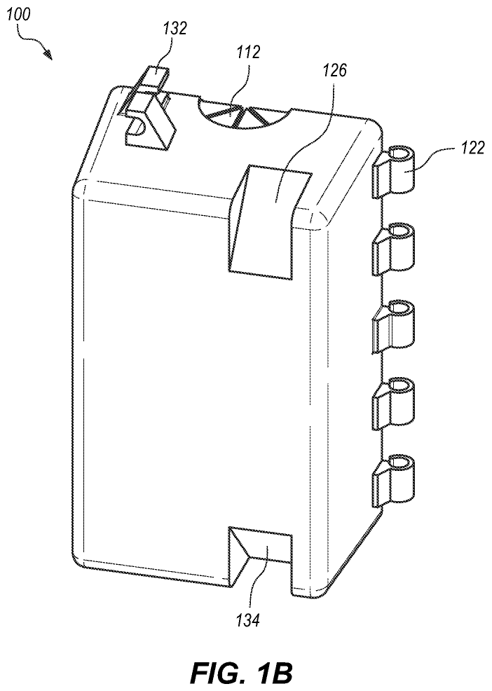

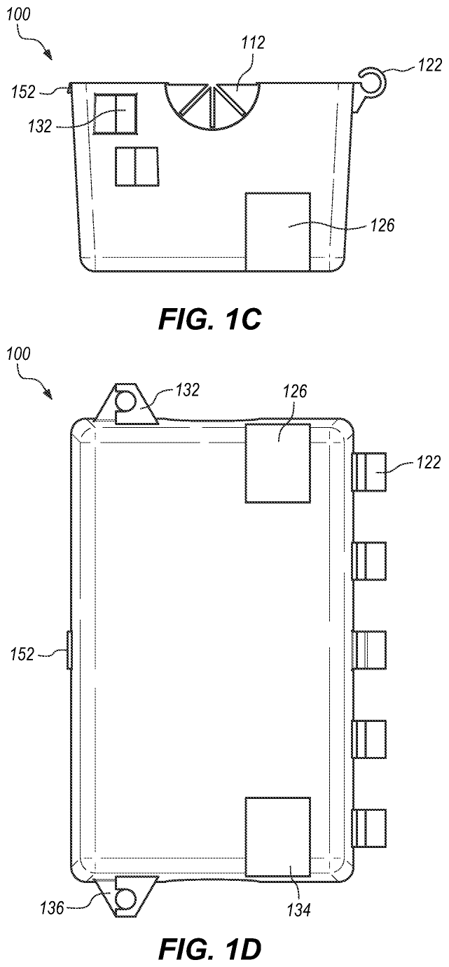

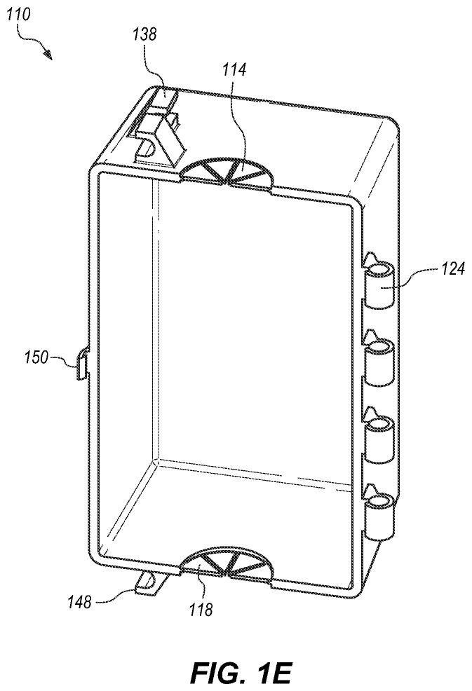

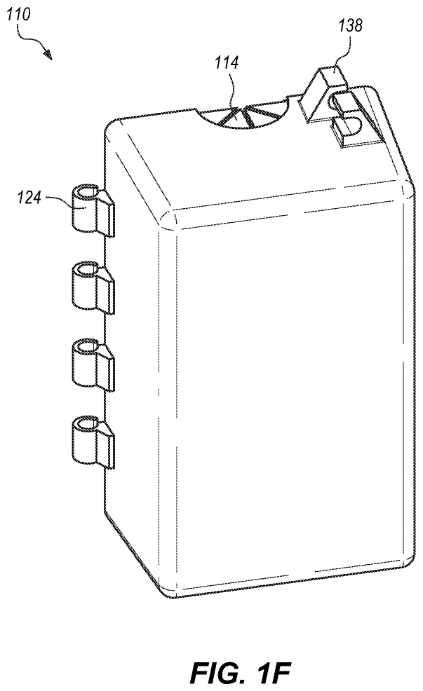

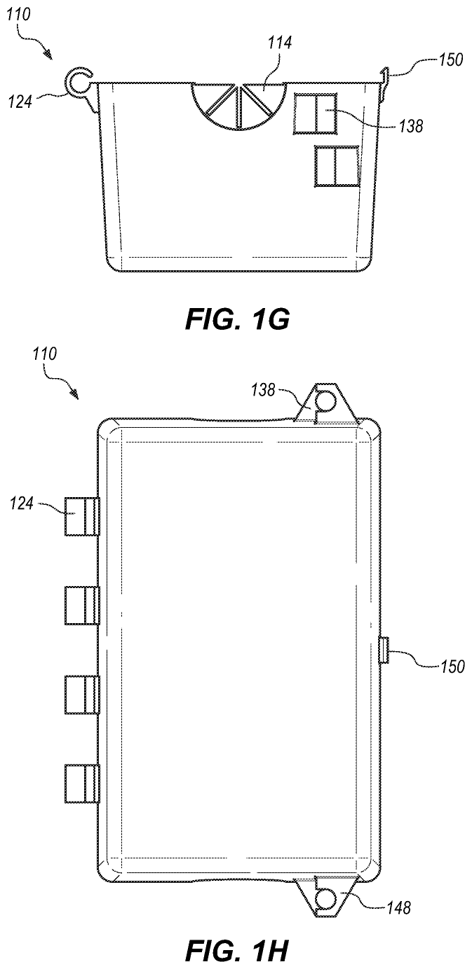

FIG. 1A illustrates a front angled view of a first half of a splice box according to example embodiments of the present application. Referring to FIG. 1A, the first half 100 may be a substantially rectangular (or square) shape with a side hinge column 122 (hinge column), one or more punch-outs 126 and 134, which may be formed during manufacturing to provide a collapsible surface that can be broken, bent or pushed aside to provide access to the inside of the box. The top portion may have a first half of a bushing 112 and the bottom portion may have a second first half of a bushing 116. The top portion may also have a pass-through slot 132 to lock the first and second halves of the box with a nail or other rod-shaped element. The bottom portion may also have a pass-through slot 136 to lock the first and second halves of the box with a nail or other rod-shaped element when both halves are in a ‘closed box’ position. The hinge column 122 may also support a rod-shaped element to hold the first and second halves together in a closed position. In one example, one of the slots 132 and/or 136 may be removed.

FIG. 1B illustrates a rear angled view of a first half of a splice box according to example embodiments of the present application. Referring to FIG. 1B, the rear view illustrates that the half box is generally rectangular-shaped, although other shapes may be used. The depth of the half box 100 is approximately between one and three inches depending on the specific application required to splice cable and house the cable splice in the box. The bushings may be a same material as the box or half box, which is a plastic or poly-material plastic. Also, metal, rubber, glass or other materials may be used. The bushing depth may be thinner than the rest of the half box to provide flexibility or even the ability to be easily broken to permit the wiring to pass-through the bushing. The punch-outs 126/134 may also be a thinner material and/or may be perforated or slit to provide a start when a user seeks to press through that area and push a cable into the box at that location.

FIG. 1C illustrates a top view of a first half of a splice box according to example embodiments of the present application. Referring to FIG. 1C, the top demonstrates how the depth of the box half is smaller than the length of the box half from top to bottom (FIG. 1D), which is generally about three to six inches in length. Also, the lip (tab) 152 on the side opposite the hinge column 122 provides a way to snap the box into a locked position where the securing tab 150 (see FIG. 1G) can lock against the lip 152. The lip and tab may be larger than what is illustrated in the drawings and may be one inch or more in size depending on the design.

FIG. 1E illustrates a front angled view of a second half of a splice box according to example embodiments of the present application. Referring to FIG. 1E, the second box half 110 includes a similar configuration, although the tab 150 provides a resting surface for the securing lip 152 to maintain a locked position. The top includes a second half bushing structure 114 and the bottom includes a lower second half bushing structure 118. The side includes a hinge column 124 intended to intermate with the hinge column 122 of the first half and to be secured by a rod-shaped element (not shown). Also, the top and bottom have respective pass-through columns 138/148 which are aligned with the pass-through columns of the first box half. In another example, the hinge column may be a tongue and groove configuration without the need for a pin or rod to hold the hinge together. The hinge may be pressed together and snapped into a locking position with no rod or pin needed to secure the two halves together and provide a pivoting axis. Again, the slots 132, 136, 138 and 148 may be non-existent, may only include two of the four slots or may be a different securing mechanism.

FIG. 1F illustrates a rear angled view of a second half of a splice box according to example embodiments of the present application. Referring to FIG. 1F, like numerals refer to like elements throughout the specification.

FIG. 1G illustrates a top view of a second half of a splice box according to example embodiments of the present application. Referring to FIG. 1G, the top of the second box half has the hinge column 124 on a side opposite the first box half and has the securing tab 150 with a protruding lip or edge to secure against the securing lip surface 152.

FIG. 1H illustrates a rear view of a second half of a splice box according to example embodiments of the present application. Referring to FIG. 1H, the rear view of the second box half 110 is similar to the first box half although the hinge 124 and the pass-through slots 138/148 are on opposite sides.

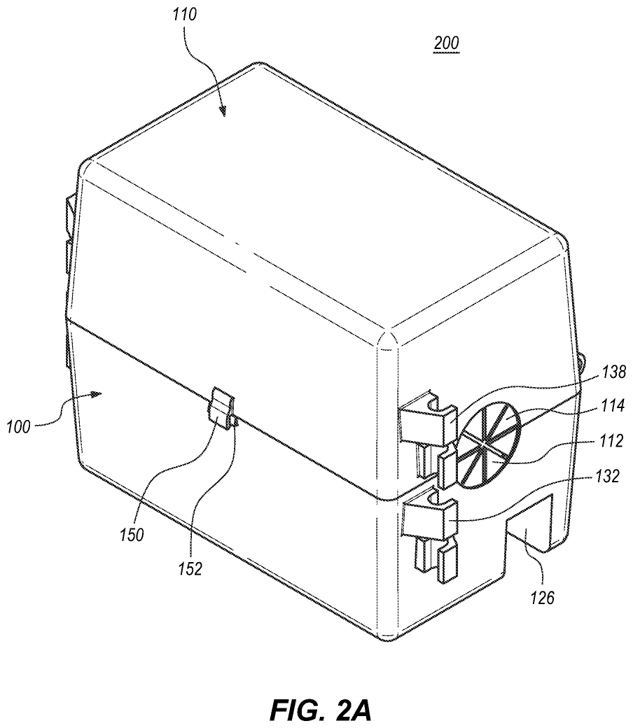

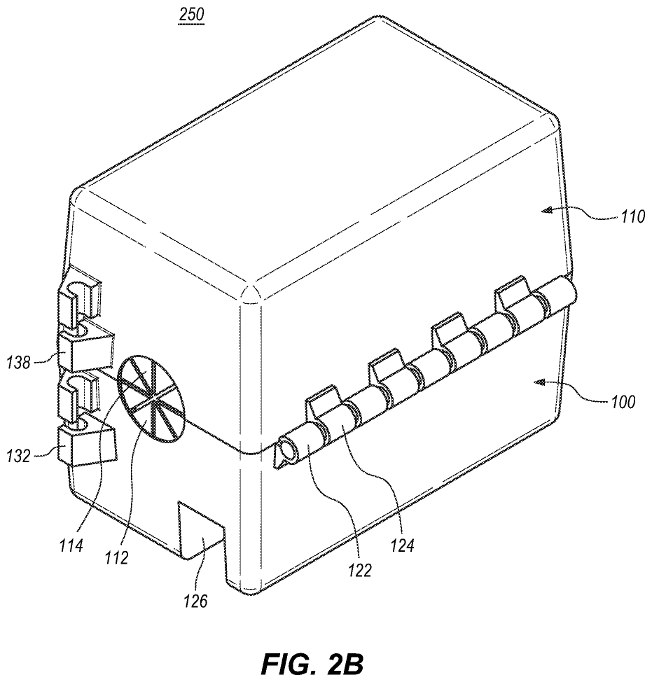

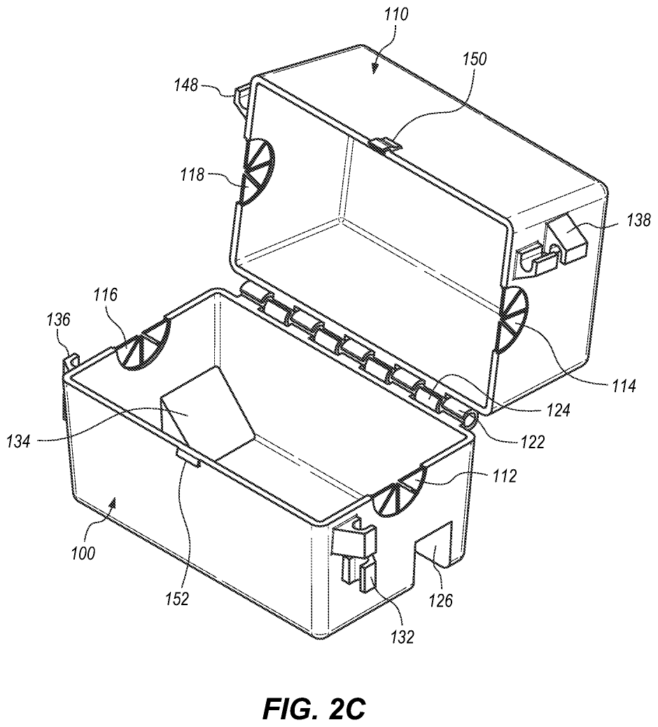

FIG. 2A illustrates a front angled view of the first half and the second half of the splice box together in a closed position according to example embodiments of the present application. Referring to FIG. 2A, the two box halves are illustrated in an example 200 where the box is in a closed position. The second half 110 and the first half 100 are locked together with the tab 150 resting against the securing lip 152. The bushing is completed with the two halves 114 and 112 forming a complete bushing. The bushing may have half the bushing tabs (four illustrated on each half) on one side and half on the other side. The cable or wire should be easily pressed into the and out of the two bushings, and/or through the punch-outs depending on the configuration. Once the splice is complete, the box may be secured around the wire (not shown).

FIG. 2B illustrates a front angled view of the first half and the second half of the splice box together in a closed position according to example embodiments of the present application. Referring to FIG. 2B, the example 250 demonstrates another angle of the completed and closed box in a locked position.

FIG. 2C illustrates a front angled view of the first half and the second half of the splice box in an open position according to example embodiments of the present application. Referring to FIG. 2C, the example demonstrates how the box is together with both halves bound by the hinge and in an open position. The wire splice could be laid in the box and closed with the wire ends (not shown) protruding out of the bushings 112/114 and 116/118 of both sides of the box. This enables the box to be closed around a splice anywhere on the wire path.

While preferred embodiments of the present application have been described, it is to be understood that the embodiments described are illustrative only and the scope of the application is to be defined solely by the appended claims when considered with a full range of equivalents and modifications thereto.

What is claimed is:

1. An apparatus comprising:
a first box half comprising
a top first half bushing; and
a bottom first half bushing; and
a second box half comprising
a top second half bushing; and
a bottom second half bushing;
wherein the first box half and the second box half are separate and are affixed to one another by a hinge with a rotating axis.

2. The apparatus of claim 1, wherein in a closed position the first box half and the second box half are locked together by a securing tab on one of the first box half and the second box half being latched onto a resting lip on the other of the first box half and the second box half.

3. The apparatus of claim 1, wherein the first box half and the second box half are bound on one side by the hinge.

4. The apparatus of claim 1, comprising
securing slots on the first box half aligned with securing slots on the second box half when the box is in a closed position.

5. The apparatus of claim 1, wherein the top and bottom second half bushings and the top and bottom first half bushings each have an equal number of bushing tabs.

6. The apparatus of claim 1, wherein the top and bottom second half bushings and the top and bottom first half bushings are a same material as the first and second box halves.

7. The apparatus of claim 1, wherein the top and bottom second half bushings and the top and bottom first half bushings are a different material as the first and second box halves.

8. The apparatus of claim 1, wherein the top and bottom second half bushings and the top and bottom first half bushings have a thinner material of a same type of material as the first and second box halves.

9. The apparatus of claim 1, wherein the top and bottom second half bushings and the top and bottom first half bushings have a thinner material of a different type of material as the first and second box halves.

10. An apparatus comprising:
a first box half comprising
a top first half bushing; and
a bottom first half bushing; and
a second box half comprising
a top second half bushing; and
a bottom second half bushing,
wherein in a closed position the first box half and the second box half form a complete top bushing and a complete bottom bushing.
